(19) United States
(12) Patent Application Publication
(10) Pub. No.: US 2002/0195741 A1
(43) Pub. Date: Dec. 26, 2002

(54) Lost core method for producing a hollow structure

(75) Inventors: Thomas Jessberger, Rutesheim (DE); Heinz Dobusch, Marbach (DE); Markus Scheerle, Sachsenheim (DE); Achim Rehmann, Kieselbronn (DE)

Correspondence Address: CROWELL & MORING LLP, INTELLECTUAL PROPERTY GROUP, P.O. BOX 14300, WASHINGTON, DC, 20044-4300, US

(73) Assignee: Filterwerk Mann & Hummel GmbH, Ludwigsburg (DE)

(21) Appl. No.: 10/151,286

(22) Filed: May 21, 2002

Related U.S. Application Data
(63) Continuation of application No. PCT/EP00/07618, filed on Aug. 5, 2000.

(30) Foreign Application Priority Data
Nov. 23, 1999 (DE) 199 56 170.2

(51) Int. Cl. B29C 33/40; B29C 33/76

(52) U.S. Cl. 264/221; 264/279; 264/317

(57) ABSTRACT

A lost core method for producing a hollow structure which method is characterized by fixing the lost core (11) which is to be used in the mold (12) with at least one insert (14), with the insert becoming part of the workpiece (10) to be produced. This is accomplished by casting the insert (14) in the hollow structure. In this way no openings for positioning the lost core (11), which subsequently would have to be closed with a cover, are created in the hollow structure (10) which is to be produced. The described process is therefore useful to advantageously influence the reliability of the resulting molded articles, as well as to favorably influence the manufacturing costs.

### CROSS REFERENCE TO RELATED APPLICATIONS

This application is a continuation of international patent application no. PCT/EP00/07618, filed Aug. 5, 2000, designating the United States of America, the entire disclosure of which is incorporated herein by reference. Priority is claimed based on Federal Republic of Germany patent application no. DE 199 56 170.2, filed Nov. 23, 1999.

### BACKGROUND OF THE INVENTION

This invention relates to a lost core method for producing a hollow structure, and to a hollow structure that is produced using this method.

The lost core process uses lost cores, which are melted out after original formation of the hollow structure. Such a lost core is disclosed, for instance, in published German patent application no. DE 195 15 974 A1. According to FIG. 2 of this document, the lost core 31 is provided with a support element 10, which protrudes from the core on one side. This support element is used to fix the core inside the mold 35, so that the molded body 40 can then be injection-molded around it. Once the lost core 31 is melted out, the support element 10 can be readily removed. This makes it possible to create molded bodies with complex interior structures. The structures of the lost core that shape the interior space can, in particular, have larger dimensions than the openings provided in the hollow molded body, since the core material can be melted out after the molding process.

The lost core, however, must be fixed inside the mold prior to the injection molding process. Furthermore, the support element 10, if provided in the lost core, must be capable of being removed again through an opening in the finished hollow structure. This limits the geometric design possibilities of the hollow structure in spite of the use of lost cores with support elements.

If required for geometric reasons, additional openings must be provided in the hollow structure through which the support elements can be removed. However, these openings must be closed again after the hollow structure has been produced. One way to accomplish this is to use covers that are welded or bonded to the hollow structure. This, however, results in additional assembly costs. It also limits the functional reliability of the hollow structure because leaks can develop at such a cover.

### SUMMARY OF THE INVENTION

The object of the invention is to provide a method for producing hollow structures with a lost core that allows a free design of the geometry of the hollow structure and at the same time ensures reliable fixation of the lost core.

This object is attained by providing a lost core method for producing a hollow structure, wherein the method comprises the steps of positioning a lost core inside a mold to form a mold assembly; filling the mold assembly with a molding material and allowing the molding material to solidify to form the hollow structure; removing the hollow structure from the mold, and melting the core out of the hollow structure; wherein an insert is used to position the lost core, the insert becoming an integral component of the hollow structure by being at least partially covered by the molding material, and wherein the insert is cast inside the lost core, and parts of the insert protrude from the lost core.

In accordance with a further aspect of the invention, the objects are achieved by providing a hollow insert produced by the foregoing method in which the insert which positions the lost core is incorporated into and becomes a part of the molded hollow structure.

The lost core method according to the invention, which is used particularly to produce injection-molded parts, includes the generally known production steps. The lost core is positioned inside the mold and the mold is prepared for the injection molding process. A molding material is then introduced into this mold assembly where it solidifies and thus forms the hollow structure. This hollow structure is then unmolded by removing the mold parts from the mold, and the core then is melted out of the hollow structure.

The invention is characterized in that a specific positioning element is provided for the lost core. This positioning element comprises an insert for the mold, which is integrated into the hollow structure during the process of producing the hollow structure. This integration is effected by an at least partial overlap of the insert with the hollow space in which the hollow structure is to be created inside the mold. In this manner, the insert is injection-molded into the hollow structure. The insert can, in particular, form a portion of the outer wall of the hollow structure. On the outside, the part can then be supported in the mold, while on the inside it supports the lost core.

Such inserts can be positioned anywhere, even in areas of the mold geometry that are difficult to access. Until now, these areas could not be used for introducing a positioning element by means of an opening provided for this purpose, because the corresponding positioning tool could not be brought to the required location. The use of an insert according to the present invention avoids this problem.

The insert can be fixed in a corresponding recess inside the mold. In accordance with one specific embodiment of the inventive concept, however, the insert can alternatively be fixed in the lost core. The insert can, for instance, be cast into the lost core such that parts of the insert still protrude from the lost core. These parts then permanently combine the insert with the hollow structure. This variant simplifies the handling of the individual parts used in the production process of the hollow structure.

The insert is integrated into the lost core, so that its position is clearly defined. The insert can, for instance, be used as a spacer between the lost core and the mold wall, so that it becomes an integral component of the hollow-structure wall to be produced in this area. This eliminates the necessity for a cover, which would be required if the lost core were supported in the mold, e.g., by a corresponding mandrel.

However, the introduction of the insert into the lost core can be used in another manner, namely if it is required as a reference surface in the interior of the hollow structure, e.g., as a limit stop. Precisely this reference surface can be jointly formed by the insert.

To form complex hollow structures, it may be necessary to use multi-element lost cores for the hollow structure. These multi-element lost cores must be positioned not only relative to the mold but also relative to one another. According to a further embodiment of the invention, inserts can again be used for this purpose. These inserts must in some way be integrated into the finished hollow structure. It is feasible, for instance, for a hollow structure to comprise two chambers and for the two lost cores that form the respective hollow spaces to be connected by an insert in the area of the partition which separates the hollow spaces from each other. When the injection molding process is completed, the insert forms a part of this wall or partition. The cores can be threaded onto a common element to facilitate their mutual positioning.

A different material may be selected for the insert than for the hollow structure. The selection of the material for the insert also depends, of course, on the function of the finished hollow structure. It is possible, for instance, to select a harder material for the insert than for the hollow structure if the insert is to be simultaneously used as a reference surface for bearings.

If, however, the insert is not intended to fulfill any other function in addition to positioning the lost core, it is particularly advantageous to produce the insert from the same material as the hollow structure. As a result, the insert is melted onto the boundary surface of the hollow structure to be formed, which produces a particularly durable bond. This bond can satisfy even high sealing requirements to be met by the hollow structure.

A hollow structure produced in accordance with the described method may comprise an insert, which in addition is provided with a profile. This profile then forms a positive-locking connection with the hollow structure. This produces on the one hand a durable connection and on the other hand enlarges the effective contact surface between the insert and the hollow structure, which ultimately enhances the sealing effect at the joint.

A specific embodiment of the hollow structure is obtained if the insert which is used is integrated into the hollow structure in such a way that a relative movement between these two parts is possible. It is feasible, for example, to provide an annular insert, which is simultaneously used to support a shaft. The relative movement can be designed such that the bearing ring can be replaced. Thus, two functions are performed. By introducing the bearing ring during the production process of the hollow structure, the lost core is positioned on the one hand and an assembly of the bearing ring after production of the hollow structure is eliminated on the other hand. The worn bearing ring can nevertheless be replaced.

The insert, however, could also be a functional part, e.g., a butterfly valve, the valve blades of which can be cast into the lost core in such a way that the valve shaft protrudes from the lost core and is thus cast into the wall. If the butterfly valve material does not adhere to the material of the hollow structure, the result is a rotatably supported butterfly valve, which is assembly-molded into the intake manifold.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIG. 1 shows a longitudinal section through an intake manifold for a two-cylinder internal combustion engine, half of which is shown with the mold and lost core and half of which is shown without the core;

FIG. 2 shows a detail X of FIG. 1, and

FIG. 3 shows an alternative embodiment of the insert in area Y of FIG. 1.

### DETAILED DESCRIPTION OF PREFERRED EMBODIMENTS

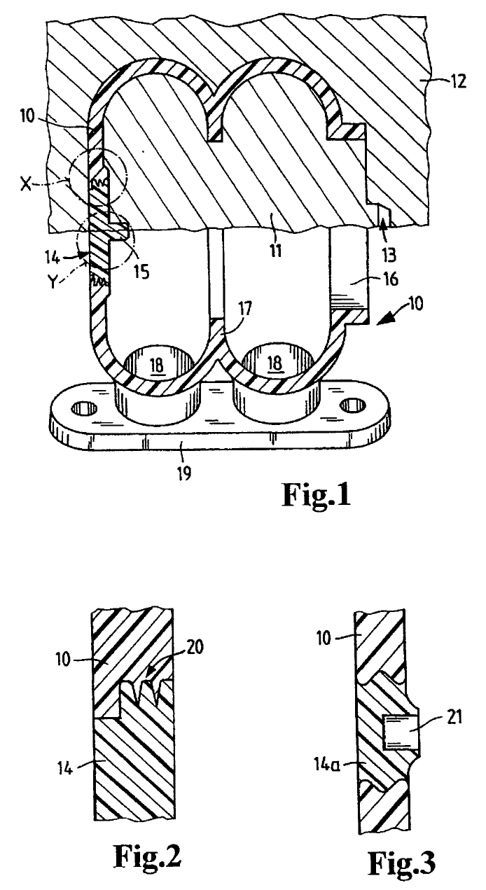

An intake manifold 10 according to FIG. 1 can be produced by means of a lost core process. To this end, a lost core 11 is introduced into a mold 12 as shown in the upper area of FIG. 1. The resulting hollow space formed between the lost core and the mold is then filled with synthetic resin material. This creates the intake manifold 10 as the hollow structure.

The core can be positioned in a known manner inside the mold in a recess 13. This is done on the side on which the intake manifold in any case requires an installation opening for an assembly part, for example for a drum-type controller. On the other side of the intake manifold, no opening is required in the manifold wall. Here, an insert 14 is used, which can be fixed in the lost core by a mandrel 15.

The insert is made of the same material as the intake manifold 10. Mandrel 15 is inserted into an assembly opening 16 in the lost core. The assembly opening is undersized relative to the mandrel. This brings about a fixation that makes it easier to introduce the unit of lost core and insert into the mold.

The structure of the intake manifold is illustrated in the lower half of the figure. The use of a drum-type controller requires undercuts in the form of a radial rib 17, which makes it necessary to produce the intake manifold using a lost core process. The insert is not shown. It comprises a plenum, which forms annular channels inside the intake manifold housing. These channels end in outlets 18 for the combustion air, which can be connected to an internal combustion engine (not shown) via a cylinder head flange 19.

As can be seen from FIG. 2, the insert, along the interface to the intake manifold housing, is provided with a profile 20, which results in a positive-locking connection between insert and intake manifold housing. If the insert and the intake manifold housing are made of the same material, this connection melts so that a single component is produced.

FIG. 3 shows an alternative embodiment of an insert 14a. This insert simultaneously forms a bearing 21 for a shaft (not shown). This bearing could be used, for instance, to rotatably support the drum-type controller for the intake manifold. In this embodiment, the material for the insert can advantageously be selected based on its tribological properties with respect to the component to be supported.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scpoe of the appended claims and equivalents thereof.

What is claimed is:

1. A lost core method for producing a hollow structure, wherein said method comprises the following steps:
positioning a lost core inside a mold to form a mold assembly;
filling the mold assembly with a molding material and allowing the molding material to solidify to form the hollow structure;
removing the hollow structure from the mold, and
melting the core out of the hollow structure;
wherein an insert is used to position the lost core, said insert becoming an integral component of the hollow structure by being at least partially covered by the molding material, and
wherein the insert is cast inside the lost core, and parts of the insert protrude from the lost core.

2. A method according to claim 1, wherein said hollow structure comprises an intake manifold for an internal combustion engine.

3. A method according to claim 1, wherein a plurality of lost cores are used to form the hollow structure and are positioned relative to one another by an insert.

4. A method according to claim 1, wherein the insert and the hollow structure are made of the same material.

5. A hollow structure, produced by the method of claim 1, wherein the insert is provided with a profile that forms a positive locking connection with the hollow structure.

6. A hollow structure according to claim 5, wherein the insert forms a part of the outer wall of the hollow structure.

7. A hollow structure produced by the method of claim 1, wherein the insert and the hollow structure are movable relative to each other.
